(19) United States
(12) Patent Application Publication
(10) Pub. No.: US 2015/0123003 A1
(43) Pub. Date: May 7, 2015

(54) HIGH RESOLUTION ABSORPTION IMAGING USING ANNIHILATION RADIATION FROM AN EXTERNAL POSITRON SOURCE

(71) Applicant: University of Kentucky Research Foundation, Lexington, KY (US)

(72) Inventor: Michael Kovash, Lexington, KY (US)

(21) Appl. No.: 14/527,827

(22) Filed: Oct. 30, 2014

Related U.S. Application Data
(60) Provisional application No. 61/900,740, filed on Nov. 6, 2013.

(51) Int. Cl. G01T 1/29; G01T 1/16; G01T 1/20

(52) U.S. Cl. CPC G01T 1/2985; G01T 1/20; G01T 1/1603
USPC 250/362; 250/363.01

(57) ABSTRACT

An apparatus, and method of using the same, for generating multiple high resolution absorption projection images which can be further processed to yield a high resolution tomographic image using annihilation radiation wherein the apparatus includes an array of gamma-ray tagging detectors and associated digitizing electronics, an array of gamma-ray absorption detectors and associated digitizing electronics, a positron source, a sample to be imaged, and a controller.

This utility patent application claims the benefit of priority in U.S. Provisional Patent Application Ser. No. 61/900,740, filed on Nov. 6, 2013, the entirety of the disclosure of which is incorporated herein by reference.

### TECHNICAL FIELD

This document relates generally to the fields of medical and industrial imaging and, more particularly, to an apparatus used to measure high resolution absorption images of a sample and to a method of using the same.

### BACKGROUND

Medical imaging has led to marked improvements in the diagnosis and treatment of numerous medical conditions in both children and adults. Not surprisingly, many imaging procedures and/or techniques have been proposed, including computed tomography (CT), fluoroscopy, and radiography. Nevertheless, x-ray projections—these are the familiar dental and chest images, for example, and they form the basis of the CT imaging method—have proven to be the most widely used imaging technology within the medical field.

A typical imaging apparatus creates a flux of x-rays by directing a beam of energetic electrons onto a metal surface. The resulting spectrum of x-ray energies encompasses discrete lines which are characteristic of the target metal, as well as a continuous distribution spanning a wide range of photon energies. A two-dimensional (2D) projection image is a record of the number of x-rays which transit an absorbing sample by any direct or indirect path and are recorded either on film or in position-sensitive x-ray detectors. These 2D projections, collected over a range of x-ray beam directions, can be used to construct a three-dimensional CT image which reveals the internal structure of the sample.

Such devices based on the use of x-ray beams, however, are not without significant problems and limitations which are set by the fundamental nature of x-ray interactions. First, at the energies produced by typical x-ray equipment, a large fraction of the photons scatter within the sample, instead of being absorbed or transmitted. The scattered photons are necessarily deflected, and those which exit the sample are often recorded on film or in a detector which is not located along the x-ray's original direction of travel. In this way photon scattering (also known as Compton scattering) introduces a background signal into the recorded image which significantly reduces the projection contrast. Importantly, the variation in this scattering background across the projected image is often as large, or larger, than the small differences in the absorption created by the structures of interest within the sample. Secondly, because the lowest-energy components of the x-ray beam interact most strongly in the sample, these components of the beam are preferentially absorbed within the first few sample layers. Since the absorption which occurs in the sample depends on both the photon energy as well as the sample's physical composition, interpreting the absorption projection in terms of its internal structures is made complicated by the changing beam spectrum as it passes through the sample. Both the scattering of x-rays and the preferential absorption of the low energy components of an x-ray beam have the net effect of reducing the fidelity of the image and complicating its interpretation.

Additionally, typical x-ray imaging methods generate ionizing radiation which is a significant concern in medical applications. In large enough doses absorbed radiation has been shown to cause harm to patients. It should be readily appreciated that a beam of x-rays is highly attenuated as it passes through a “thick” absorber (i.e. a human torso, bone, or any other dense material, and especially those composed of atoms with a high atomic number). Thus in many instances, an intense, incident x-ray beam is required to produce a high-quality image because the recorded projection is simply a mapping of the number of x-rays which transit the absorber. Accordingly, in clinical applications, the absorbed and internally scattered x-rays produce a radiation dose within the patient—an effect which is compounded by the high intensity of the incident beam.

The very large attenuation rate of x-rays in some materials can produce false artifacts in CT images in both medical and industrial applications. As one example, the strong x-ray attenuation created by metal implants can produce false artifacts in computed tomographic images.

### SUMMARY

In accordance with the purposes described herein, a high resolution sample imaging apparatus is provided for generating a two-dimensional and/or three-dimensional image of a sample or object of interest. The apparatus may be broadly described as comprising: (a) a positron source emitting oppositely-directed annihilation radiation pairs, (b) an array of gamma-ray tagging detectors, (c) an array of gamma-ray absorption detectors, (d) a sample to be imaged, and (e) a controller in the form of a computing device. The positron source is positioned between the array of gamma-ray tagging detectors and the array of gamma-ray absorption detectors, while the sample is positioned between the positron source and the array of gamma-ray absorption detectors.

In one embodiment, the apparatus further includes a gamma-ray collimator assembly. The gamma-ray collimator assembly serves multiple functions, including the masking of the annihilation radiation into a pair of collimated beams, as well as the general shielding of the radioactive, positron source.

In one embodiment, the gamma-ray collimator assembly is cylindrical. In additional, related embodiments, the gamma-ray collimator assembly includes: (a) a first aperture positioned between the positron source and the array of gamma-ray tagging detectors, (b) a second aperture positioned between the positron source and the array of gamma-ray absorption detectors, and (c) a sidewall. The apertures may be positioned on opposing endpoints of the gamma-ray collimator assembly, and, in some instances, may be positioned on the center-line of the gamma-ray collimator assembly along the length of the gamma-ray collimator assembly.

In one embodiment, the positron source is a β⁺ emitter material. In related embodiments and configurations, the positron source is of a shape which has diameter of about 2 mm. Additionally, within the gamma-ray collimator assembly, the positron source may be contained within a capsule.

In an additional embodiment, the apparatus includes a mechanism for adjusting the position of the positron source. In particular, the mechanism permits movement of the positron source laterally away from the central axis of the collimator. The resulting small variance in the set of observed radiation trajectories through the sample allows the sample to be studied with a finer position resolution.

In yet another embodiment, the array of tagging detectors includes a plurality of unit cells. Each unit cell includes a region of scintillator material and a light sensor.

In a further embodiment, the array of absorption detectors includes a plurality of unit cells and light sensors; such a configuration is similar to the configuration described above relating to the array of tagging detectors.

In accordance with purposes described herein, a method is provided for generating an image using directed energy lateral tomographic analysis (DELTA). The method can, for example, be used in direct correlation with the apparatus herein described. The method may be broadly described as comprising the steps of: (1) positioning a sample to be imaged between a positron source and an array of gamma-ray absorption detectors, (2) directing one member of an annihilation radiation pair from the positron source towards the array of gamma-ray tagging detectors and the other toward an array of gamma-ray absorption detectors, (3) detecting the arrival time, position, and energy of the tagging member of the annihilation pair at the array of gamma-ray tagging detectors, and (4) detecting the arrival time, position, and energy of the absorption member of the annihilation pair at the array the array of gamma-ray tagging detectors, if it transits the absorbing sample.

In one embodiment, the annihilation radiation pair includes a tagging photon and a probe photon; both the tagging and probe photons have an initial energy of exactly 511 keV. The tagging photon is directed from the positron source towards the array of gamma-ray tagging detectors. The probe photon is directed from the positron source towards the array of gamma-ray absorption detectors. The absence of a detected probe photon at a location exactly back-to-back to a detected tagging photon is indication of an absorption or scattering event in the sample. Repeated measurements of the likelihood of this occurrence for each possible tagged photon trajectory are used to form a 2D absorption projection of the sample.

In an additional embodiment, the collection of 2D projections thus measured using probe photons entering the sample over a very wide range of angles and positions is used to form a three-dimensional tomographic image.

In the following description, there are shown and described several preferred embodiments of the high resolution sample imaging apparatus and method of using the same. As it should be appreciated, both the apparatus and method are capable of different embodiments than the ones specifically disclosed herein. The details of the apparatus and method are capable of modification in various, obvious aspects, all without departing from the apparatus and method as set forth and described in the claims. Accordingly, the drawings and descriptions should only be regarded as illustrative in nature and not as restrictive.

### BRIEF DESCRIPTION OF THE DRAWINGS

The accompanying drawings incorporated herein and forming a part of the specification, illustrate several aspects of the high resolution imaging apparatus and together with the description serve to explain certain principles thereof. In the drawings:

FIG. 1 is a schematic illustration of one possible configuration of the high resolution imaging apparatus;

FIG. 2 is a three-dimensional schematic view of the apparatus in FIG. 1;

FIG. 3 illustrates the characteristic trajectories and interactions of an annihilation radiation pair in the apparatus of FIG. 1.

FIG. 4 illustrates additional components of the collimator assembly.

FIG. 5 illustrates the connection between the scintillators, the light sensors, and the pulse-digitizing electronics in the array of gamma-ray tagging detectors.

FIG. 6 illustrates the contents of a unit cell in the array of gamma-ray tagging detectors.

FIG. 7 illustrates the positioning of a sample to be imaged relative to the array of gamma-ray absorption detectors.

FIG. 8 illustrates one possible algorithm used in the disclosed method to form a projected image using the data collected by the high resolution imaging apparatus of FIG. 1.

### DETAILED DESCRIPTION

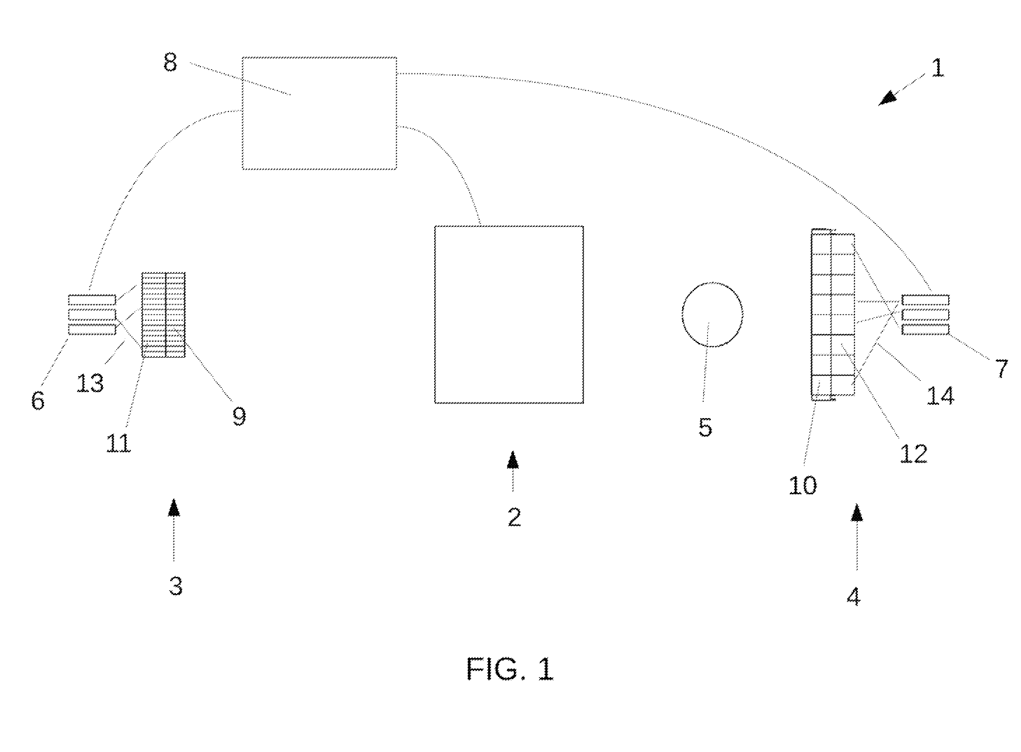

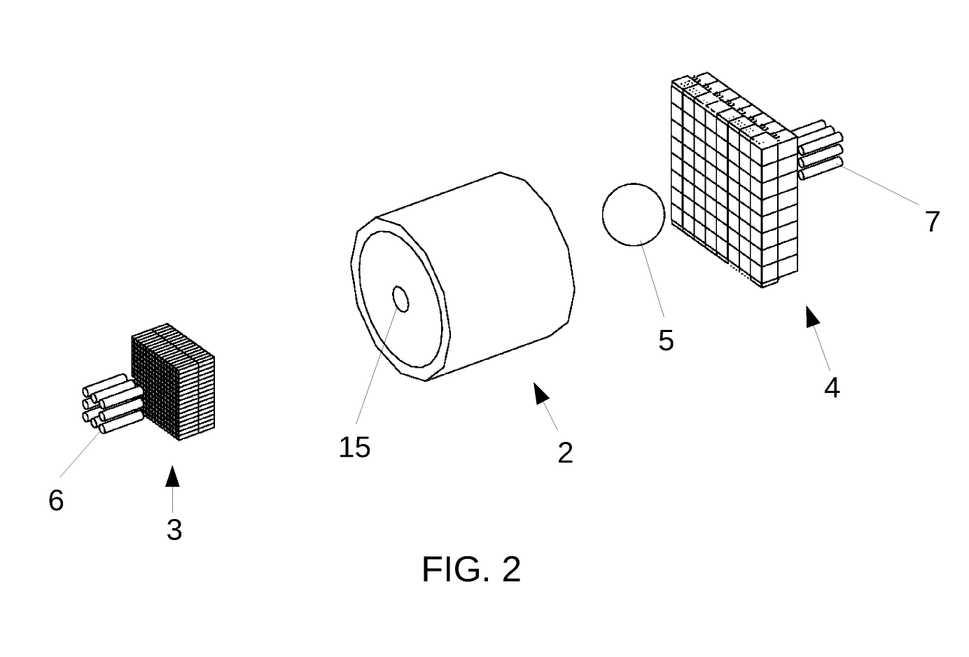

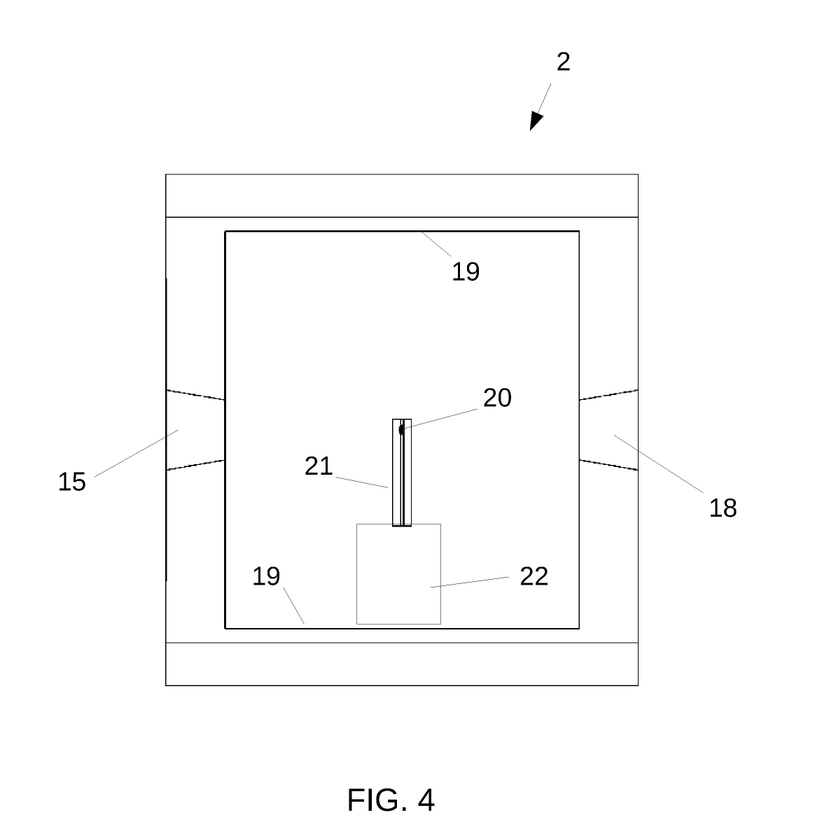

Reference is now made to FIGS. 1, 2, 3 and 4 generally illustrating the high resolution imaging apparatus (1). As best illustrated in FIGS. 1 and 4, a positron source (20) is located within an encompassing capsule (21) and a collimator assembly or lead shield (19). The positron source (20) consists of a sample of a β+ emitter material which is of a shape and a diameter of about 2 mm. The positron source/radioactive material (20) is nominally positioned on the axis of the collimator assembly (2) and centrally located along its length. The position of the positron source (20) acts to direct an annihilation radiation pair (16, 17) of back-to-back 511 keV photons towards apertures (15, 18) on endpoints of the collimator assembly (2). Preferably the apertures (15, 18) are identical. Any annihilation radiation emitted and not directed toward one of the apertures (15, 18) is simply absorbed by the sidewalls (19) of the collimator assembly (2). Accordingly, only back-to-back pairs of photons can escape through the apertures (15; 18).

As best illustrated in FIG. 4, the collimator assembly (2) may further include a motorized drive mechanism (22) to make adjustments to the position of the radioactive sample (20), allowing it to move several mm away from the central axis of the collimator assembly (2). Varying the position of the positron source (20) allows the apparatus (1) to map variations in the absorption profile of the sample or object (5) under study which are smaller than the size of the individual cells of the array of tagger detectors (9).

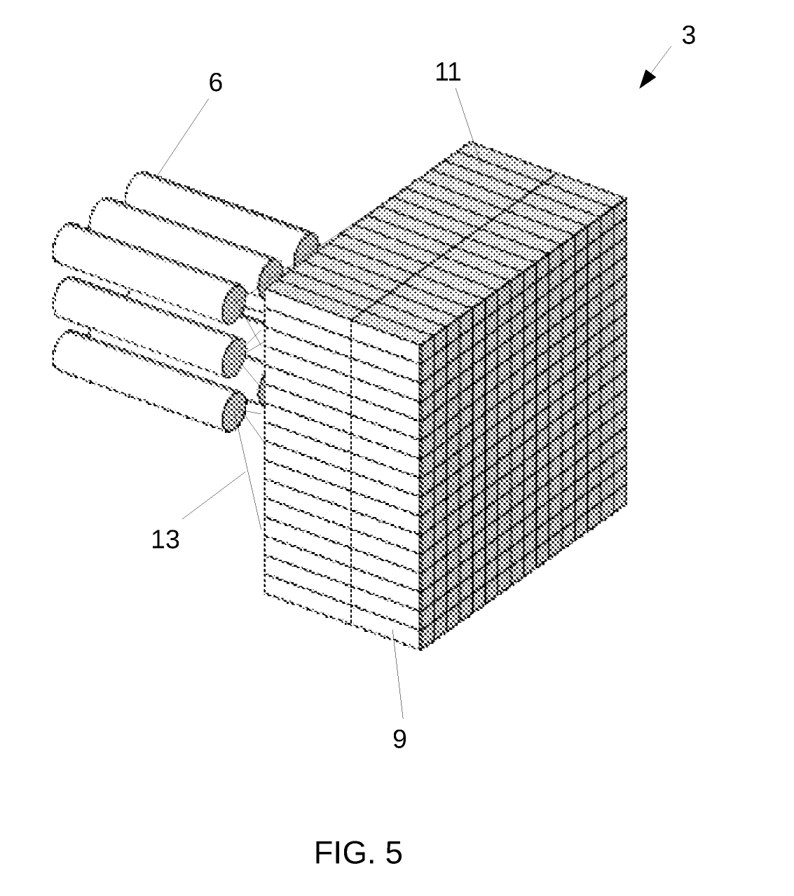

Reference is now made to FIGS. 1, 5, and 6. As shown therein, the apparatus (1) includes an array of gamma-ray tagging detectors (3) composed of unit cells (24). Each unit cell (24) further includes a region of scintillator material (9) and a light or optical sensor (11). The geometric coverage of the array (3), in conjunction with the size of collimator aperture (15), sets the range of accepted emission angles for tagged photons. The tagger array's overall size, degree of granularity, cell size, and separation from the positron source (20) can be adjusted to accommodate a variety of illumination configurations. Preferably, however, the array of tagging detectors (3) should include about 256 optically-isolated unit cells (24) arranged in a segmented, 16×16 grid pattern.

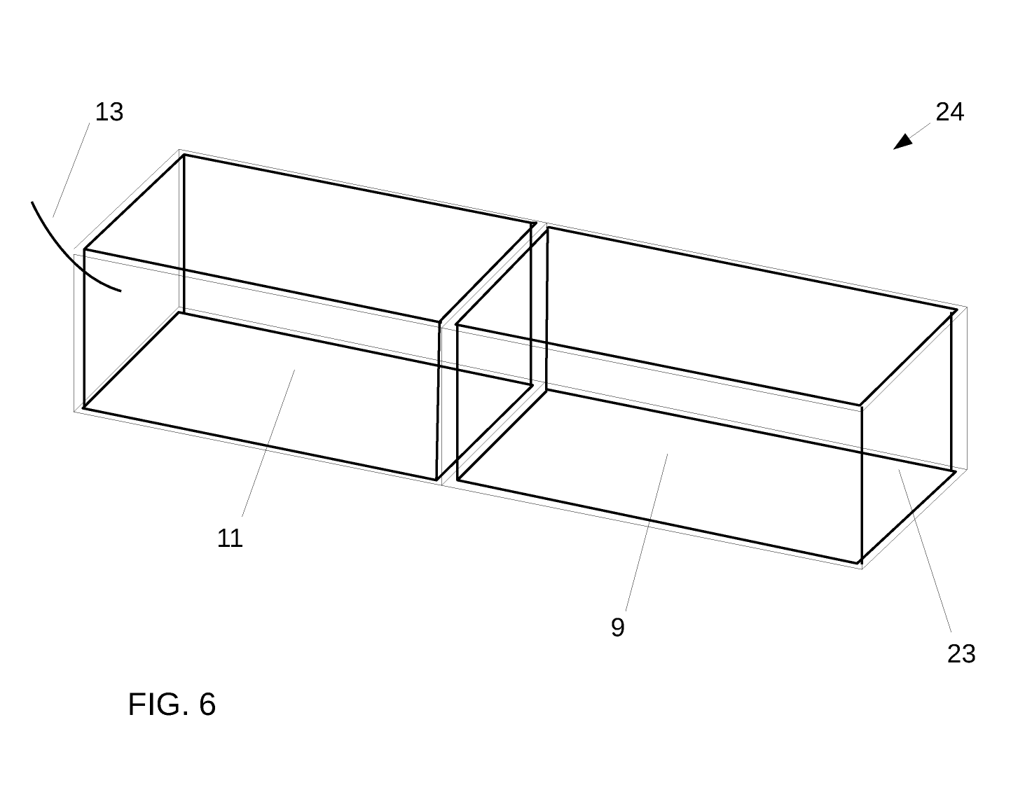

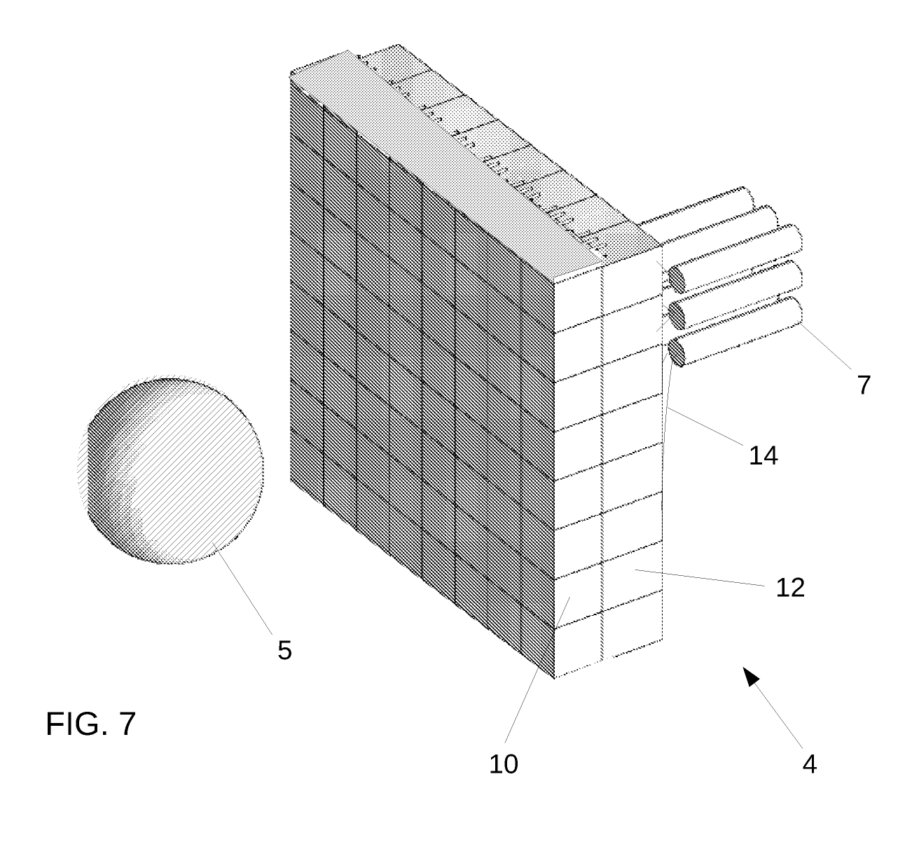

Reference is now made to FIGS. 1, 6 and 7. The apparatus also includes a sample of photon-absorbing material (5) whose absorption projection profile is to be measured. As shown in FIG. 1, the sample (5) is preferably positioned between the positron source (2) and an array of gamma-ray absorption detectors (4) comprising a plurality of scintillation detectors (10). As should be appreciated, the absorption array (4) has the same overall width, height, and basic cellular structure as the tagger array (3). Indeed, the unit cells in the absorption array have analogous structure to those in the tagger array: each unit cell includes a region of scintillator material (10) and a light or optical sensor (12), assembled with the same arrangement as is shown in FIG. 6. However, the lateral dimensions of the cells in the absorption array need not be as small as those of the tagger array (3), and so fewer cells can be used. Preferably, the array of absorption detectors (4) includes about 64 optically-isolated scintillation detectors (10) arranged in an 8×8 grid pattern.

Reference is now made to FIGS. 1, 5 and 7. The high resolution imaging apparatus (1) further includes electronic pulse digitizers (6, 7) which convert the analog signals conveyed (13, 14) from the light sensors located in both the tagger array (10) and the absorption array (12) into digitized data words. This is done individually for the light sensor attached to each unit cell, and the process is repeated whenever a triggering photon interacts in the tagger array (3). The output of the digitizers (6, 7) determines the photon energy deposition in each scintillator (8, 10), the photon arrival time, and the position of the photon interaction.

A controller (8) is connected to the positron source (2), the digitizer electronics (6) located on the array of gamma-ray tagging detectors (3), and the digitizer electronics (7) connected to the array of gamma-ray absorption detectors (4). The controller (8) may, e.g., take the form of a computing device for collecting, recording and processing the absorption data of the sample (5). The controller (8) is also used to manipulate the position of the positron source (20) within the collimator assembly (2). As should be appreciated, absorption data may be derived from measurements which determine the probability of one or more interactions of the annihilation radiation within the sample (5).

Reference is now made to FIG. 6, illustrating a possible configuration of the unit cells (24) in the array of gamma-ray tagging detectors (3). As should be appreciated, such a configuration can equally be utilized for the array of gamma-ray absorption detectors (4). Each unit cell (24) is isolated from the other unit cells within the array (3) by a thin, optically-opaque wrapping. During operation of the apparatus (1), the annihilation radiation (in this case, a tagging photon) passes through an entrance face (23) of the cell (24), and the tagging photon interacts with high probability in the volume of scintillator material (9). Preferably, the scintillation material (9) is of a type which is non-hygroscopic (so as not to degrade upon contact with atmospheric moisture), readily machined, high yield (i.e. visible light yield per incident gamma ray is high), short time decaying, and reasonably priced.

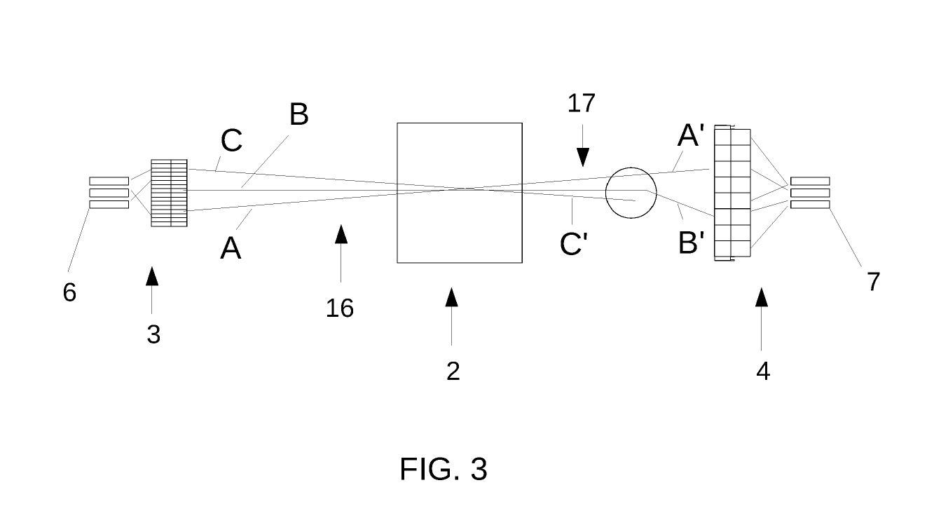

Reference is now made to FIGS. 1 and 3, showing three trajectories (A-A′, B-B′, and C-C′) characteristic of the paths a back-to-back, annihilation radiation pair (A, A′, B, B′, and C, C′) would follow during operation of the apparatus (1). As shown (16), each of the tagged photons (A, B, and C) is detected by a different unit cell (9) within the array of gamma-ray tagging detectors (3) thereby defining the initial trajectory of each of the associated probe photons (17). As shown, the probe photon (A′) which does not interact in the sample (5) is detected along the direction conjugate to that of its associated tagging photon (A). Probe photon (B′) scatters in the sample (5) and is detected in the absorption array (4), but not along the direction conjugate to its associated tagging photon (B). Probe photon (C′) is absorbed in the sample (5) and not detected. By measuring the correlation between the tagging photons (16) and the probe photons (17) using the tagging (3) and absorption (4) detector arrays, one can identify those probe photons which do not interact in the sample (A′), and those which do interact (B′, C′). Moreover, the precise region of the sample (5) probed in each case is uniquely determined by the interaction point of the tagging photon (16) within the tagger array (3). The dimensions of the beam of tagged photons determines the extent of the region of the absorbing sample which is interrogated.

In accordance with purposes described herein, a method for generating an image using directed energy lateral tomographic analysis (DELTA) shall now be described. The method may be broadly described as comprising the steps of positioning a sample to be imaged (5) between a positron source (20) and an array of gamma-ray absorption detectors (4); directing an annihilation radiation pair from the positron source (20) towards the array of gamma-ray tagger detectors (3) and an opposing array of gamma-ray absorption detectors (4); detecting the arrival time, position, and energy of one photon of the annihilation pair at the array of gamma-ray tagger detectors (3); detecting, if present, the arrival time, position, and energy of the second photon of the annihilation pair at the array of gamma-ray annihilation detectors (4); processing absorption data of said sample from said annihilation radiation pair, and the arrays of gamma-ray detectors (3, 4). The absorption data may include any information relating to the annihilation radiation pair (16, 17) such as energy, trajectory, position and/or arrival time.

Using the DELTA method, a computed tomographic image of the sample (5) may be constructed from a set of projections collected by the apparatus (1) over a range of illumination angles. This is accomplished either by rotating the sample (5) about an axis through its center, rotating the entire apparatus (1) about an axis through the center of the sample (5), or surrounding the sample with multiple copies of the apparatus (1).

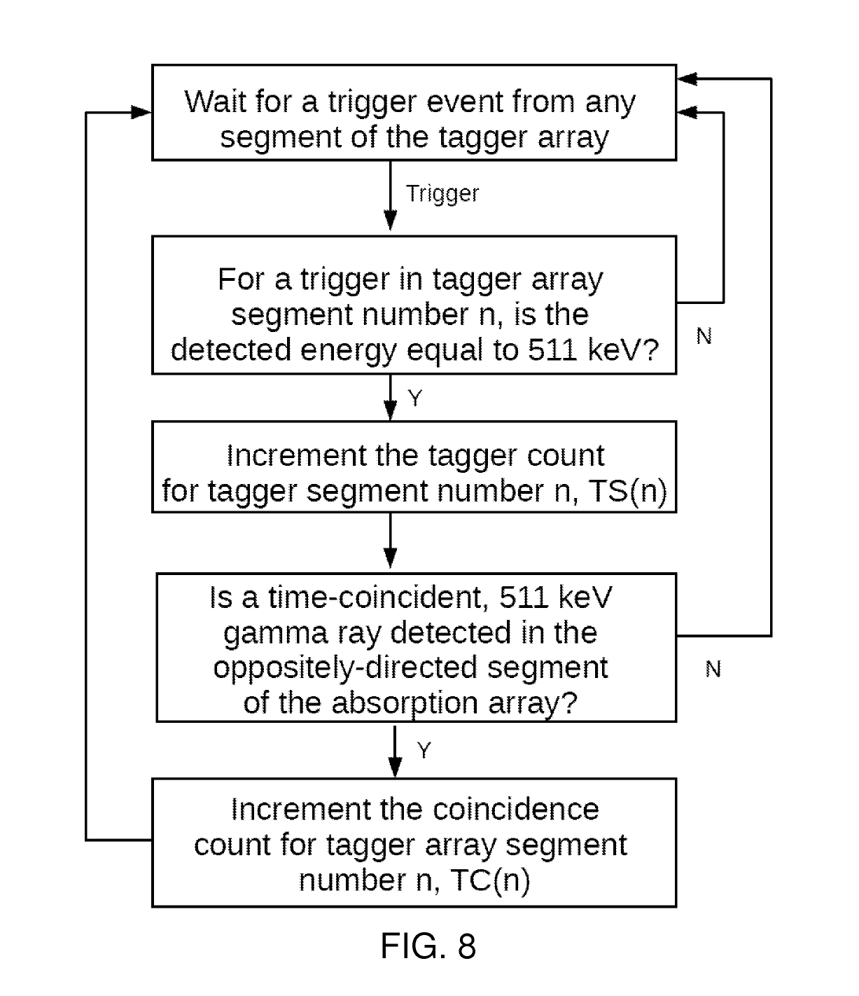

Reference is now made to FIGS. 1 and 8. The controller (8) includes, or is programmed with, an algorithm for collecting the digitized data. Upon the arrival of a trigger event from the tagger array (3), the pulses from all of the optical sensors (11, 12) in both arrays are digitized, yielding information on photon energy deposition, arrival time, and position. Such data collected using triggers originating from all regions of the tagger array, and with multiple positions of the positron source, are processed by the controller to yield a high resolution 2D projection image of the sample absorption profile.

A tally is formed of the number of events in which annihilation radiation is detected in the tagger array (3), and this is done without consideration of a possible hit in the absorption array (4). These are called “singles” counts, and a separate tally is maintained for each tagger cell (24). For tagger cell number n, this tally is labeled: TS(n) [“tagger-singles-n”]. For example, FIG. 3 illustrates three such trigger events (A, B, and C).

For each trigger event, the oppositely-directed probe photon may or may not be detected in coincidence in the opposing location of the absorption array (4). If not, then the probe photon was either absorbed or it was scattered. (A third possibility is that the absorber detector did not register an interaction of an incident probe photon. A small correction for this possibility, as determined with a calibration procedure, can be applied to the recorded data.) When a coincident annihilation photon is detected in the absorption array (4) in the cell positioned opposite to the struck tagger cell—cell number n in the tagger array, say—a separate “tagger coincidence” tally, TC(n), is incremented by one. For example, FIG. 3 illustrates this event as A-A′; for such an event, both tallies TS(n) and TC(n) are each incremented by 1.

After data has been collected for a large number of tagger-singles and tagger-coincidence events the probability of absorption of the probe photon along the track corresponding to tagger unit cell n, PA(n), is computed by forming the ratio:

PA(n)=1−[TC(n)/TS(n)]

Measured values of PA(n) for all values of n spanning the full area of the tagger array, and with multiple positions of the positron source, are combined to yield the absorption projection. Projection images measured from a wide range of viewing angles are combined to produce a tomographic image.

In summary, numerous benefits result from employing the concepts disclosed in this document. Several particularly noteworthy features of this result are: (A) the absolute, not the relative, probability for absorption is simultaneously determined along numerous well-defined paths within the absorbing object; (B) the achievable position resolution for structural features located within the absorbing sample is smaller than the size of the detector cells used in the tagger array. This is achieved by using a mm-sized annihilation source with adjustable position, and, if desired, by simply locating the tagger array further from the positron source than the distance from the source to the absorbing object; (C) the measured absorption profile does not include the background contribution of photons which scatter in the absorbing object; (D) the interpretation of the measured absorption is considerably simplified since only photons with exactly 511 keV of energy are retained and used to determine the attenuation profile; and (E) the photon absorption probability at 511 keV is considerably smaller than at x-ray energies. This greater transparency allows for improved imaging of metal and other highly absorbing structures, and reduces the number of incident photons required to produce an image. The net result of these features is a projection image which is more amenable to accurate tomographic analysis, and one which maintains a higher degree of fidelity to the true absorption profile.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A high resolution sample imaging apparatus, comprising:
an array of gamma-ray tagging detectors;
an array of gamma-ray absorption detectors;
a positron source positioned between said array of gamma-ray tagging detectors and said array of gamma-ray absorption detectors;
a sample, positioned between said positron source and said array of gamma-ray absorption detectors; and
a controller in a form of a computing device connected to said array of gamma-ray tagging detectors, said array of gamma-ray absorption detectors, and said positron source.

2. The apparatus of claim 1, further including a gamma-ray collimator assembly surrounding said positron source.

3. The apparatus of claim 2, wherein said gamma-ray collimator assembly is cylindrical.

4. The apparatus of claim 3, wherein said gamma-ray collimator assembly includes a first aperture positioned between the positron source and said array of gamma-ray tagging detectors, a second aperture positioned between the positron source and said array of gamma-ray absorption detectors, and a sidewall.

5. The apparatus of claim 4, wherein said first and second apertures are centered on the central axis of the gamma-ray collimator assembly.

6. The apparatus of claim 1, wherein said positron source is a β⁺ emitter material.

7. The apparatus of claim 6, wherein said positron source has a diameter of about 2 mm.

8. The apparatus of claim 7, wherein said positron source is contained within a capsule.

9. The apparatus of claim 1, further including a mechanism for adjusting the position of the positron source relative to the central axis of said gamma-ray collimator assembly.

10. The apparatus of claim 1, wherein said array of tagging detectors comprises a plurality of unit cells, each unit cell including a region of scintillator material and a light sensor.

11. The apparatus of claim 10, wherein said plurality of unit cells are positioned in a 16×16 grid pattern.

12. The apparatus of claim 10, wherein each unit cell of said plurality of unit cells is isolated from the other unit cells by a thin, optically-opaque wrapping and wherein said apparatus further includes electronic pulse digitizers to convert analog signals from said light sensors into digitized data.

13. The apparatus of claim 1, wherein said array of absorption detectors comprises a plurality of unit cells, each unit cell including a region of scintillator material and a light sensor.

14. The apparatus of claim 13, wherein said plurality of unit cells are positioned in an 8×8 grid pattern.

15. The apparatus of claim 13 further including electronic pulse digitizers to convert analog signals from said light sensors into digitized data.

16. A method of producing a high resolution projection image of a sample, comprising:
positioning said sample between a positron source and an array of gamma-ray absorption detectors;
directing an annihilation radiation pair from said positron source towards said array of gamma-ray absorption detectors and an array of gamma-ray tagging detectors;
detecting the arrival time, position, and energy of said annihilation radiation pair at said array of gamma-ray absorption detectors and said array of gamma-ray tagging detectors;
processing absorption data of said sample from said annihilation radiation pair; and
forming said high resolution projection image from said absorption data.

17. The method of claim 16, further including forming a composite tomographic image from said projection images collected over a very broad range of viewing angles.

18. The method of claim 16, wherein said annihilation pair includes a tagging photon with an energy of 511 keV and a probe photon with an energy of 511 keV.

19. The method of claim 18, wherein said probe photon is directed towards said array of gamma-ray absorption detectors and said tagging photon is directed towards said array of gamma-ray tagging detectors.

20. The method of claim 17, wherein said composite tomographic image is a three-dimensional high resolution tomographic image.
